(19) United States
(12) Patent Application Publication
(10) Pub. No.: US 2003/0178485 A1
(43) Pub. Date: Sep. 25, 2003

(54) Multi-functional pda

(76) Inventor: Jae-Hak Lee, Kyunggi-do (KR)

Correspondence Address: Frank Chau, F Chau & Associates, Suite 201, 1900 Hempstead Turnpike, East Meadow, NY, 11554, US

(21) Appl. No.: 10/344,424

(22) PCT Filed: Aug. 14, 2001
(86) PCT No.: PCT/KR01/01387

(30) Foreign Application Priority Data
Aug. 14, 2000 (KR) 2000/46950
Aug. 16, 2000 (KR) 2000-47284
Aug. 16, 2000 (KR) 2000-47285
Aug. 21, 2000 (KR) 2000-483379
Aug. 21, 2000 (KR) 2000-48381

(51) Int. Cl. G06K 7/00

(52) U.S. Cl. 235/435

(57) ABSTRACT

Disclosed herein is a multifunctional PDA. The PDA includes a bar code recogninition unit 10 for recongnizing a bar code attached to a product; a data storage unit 130 for storing product information corresponding to bar codes; a key input unit 20 for inputting the commands of a user; a central processing unit 100 for interpreting the bar code recognized by the bar code recognition unit 10, searching the data unit 130 for product information such as the price of the product, selling places and the like, and outputting payment and delivery signals in response to the payment command inputted through the key input unit 20, a data transmission/reception unit 110 for transmitting a product delivery request signal to a corresponding selling place in response to product information outputted from the central processing unit 100 and transmitting a payment request signal to one of banking facilities; and a display 120 for displaying operation of the central processing unit 100.

### TECHNICAL FIELD

The present invention relates generally to a multifunctional PDA having bar code recognition, pass card, memory stick input, remote control and camera functions, and more particularly to a multifunctional PDA, in which a general PDA is provided with a bar code recognition function so a user can purchase products without additional purchasing/payment procedures and have the products delivered to desired locations, a general PDA is provided with a pass card function so if a user utilizes a pass card function when taking or getting off a subway train or bus, a unique number recorded in the PDA is immediately recognized and a transportation fare is paid, a general PDA is provided with a memory stick function so a user can input characters through a memory stick in a handwriting manner and the PDA recognizes the characters and processes the characters the same as those inputted through a keyboard, a general PDA is provided with a remote control function so a user can remotely and conveniently control a variety of electronic devices such a television, a video player, an audio player, etc., or a general PDA is provided with a camera function so a user can photograph a desired image and identify himself through iris or fingerprint identification using a charge coupled device.

### BACKGROUND ART

In general a Personal Digital Assistant (PDA) is a personal communication device in which the functions of collection, storage, processing and exchange of information are combined. The use of PDAs has increased. In more detail, the PDA can be called a portable communication terminal. The PDA is smaller than a notebook computer, but more powerful than an electronic organizer. The PDA basically provides a personal information management program for schedule management, an address directory, a memo pad, etc., can freely exchange data with personal computers, and is equipped with additional application programs aside from basically installed programs.

Currently, PDAs exploit new application fields including wireless Internet application. For example, PDAs can be basically utilized to manage personal information using basically provided programs an additionally installed application programs. Meanwhile, personal computers are equipped with personal information management programs corresponding to the personal information management programs of PDAs. Accordingly, a new personal information management method, in which the personal information can be amended, supplemented and backed up while the PDA connects with the personal computer, is proposed. Additionally, for wireless Internet, there can be implemented the principal functions of the Internet application that can be performed by personal computers, such as Web-page search, e-mail, personal computer communication, stock trading, etc. Additionally, for other applications, PDAs are applied to various fields such as management automation (the collection and exchange of data, the monitoring of work, the assignment of work, the input of orders, the transmission of bills, access to customer database, etc.), conveniences and public safety management (the report of accidents, the control of parking, emergency service and repair, the inspection of meters, maintenance and repair, and audit), transportation and inventory management (the inspection of inventory, the arrangement of work and process, etc.), financial business (the management of the agents of insurance and mutual finds), etc.

Currently, the research and development of PDAs equipped with a variety of functions are carried out. However, the development of PDAs equipped with practical functions except for functions closely related to the original function of the PDAs is not sufficient.

### DISCLOSURE OF THE INVENTION

Accordingly, the present invention has been made keeping in mind the above problems occurring in the prior art, and an object of the present invention is to provide a PDA that has multiple functions.

Another object of the present invention is to provide a PDA, in which a general PDA is provided with a bar code recognition function, so a user can purchase products without additional purchasing/payment procedures and have the products delivered to desired locations.

Still another object of the present invention is to provide a PDA, in which a general PDA is provided with a pass card function, so if a user utilizes a pass card function when taking or getting off a subway train or bus, a unique number recorded in the PDA is immediately recognized and a transportation fare is paid, thereby improving the convenience of the user.

Still another object of the present invention is to provide a PDA, in which a general PDA is provided with a memory stick function, so a user can input characters through a memory stick in a handwriting manner and the PDA recognizes the characters and processes the characters the same as those inputted through a keyboard, thereby facilitating the use of the PDA.

Still another object of the present invention is to provide a PDA, in which a general PDA is provided with a remote control function, so a user can remotely and conveniently control a variety of electronic devices such a television, a video player, an audio player, etc.

Still another object of the present invention is to provide a PDA, in which a general PDA is provided with a camera function, so a user can photograph a desired image and identify himself through iris or fingerprint identification using a charge coupled device.

In order to accomplish the above object, the present invention provides a multifunctional PDA, comprising: a bar code recognition unit 10 for recognizing a bar code attached to a product; a key input unit 20 for inputting the commands of a user through keys; a pass card process unit 30 for allowing an unique number to be recognized when taking or getting off a subway train or bus; a pen type memory stick 160 for inputting the commands of the user; a memory stick input unit 40 for receiving the input of the memory stick 160; a character recognition unit 50 for converting into characters contents inputted through the memory stick input unit 40 through a translation process of analogous keyboard operations and transmitting the characters to each of applications; a touch screen input unit 60 for inputting the remote controller manipulating commands of a user; an infrared transmission unit 70 for transmitting remote controller manipulating signals to various electronic devices such as televisions, video players, audio players, etc.; a charge coupled device 90 for inputting images; a camera control unit 80 for processing the images inputted through the charge coupled device 90; a data storage unit 130 for storing product information corresponding to bar codes, contents inputted and processed through the pass card processing unit 30, data required to be controlled by a central processing unit, and image data inputted and processed through the key input unit 20 and the camera control unit 80; a central processing unit 100 for interpreting the bar code recognized by the bar code recognition unit 10, searching the data storage unit 130 for product information such as the price of the product, selling places and the like, outputting payment and delivery signals in response to the payment command inputted through the key input unit 20, controlling and storing the input and process operation of the key input unit 20 and pass card processing unit 30; controlling the input operation of the memory stick input unit 40 and the process operation of the character recognition unit 50, controlling and storing the input operation of the key input unit 20 and the touch screen input unit 60 and the process operation of the infrared transmission unit 70, and controlling and storing the input operation of the key input unit 20 and the process operation of the camera control unit 80; a data transmission/reception unit 110 for transmitting a product delivery request signal to a corresponding selling place in response to product information outputted from the central processing unit 100 and transmitting a payment request signal to one of banking facilities; a display 120 for displaying the operation and process results of the central processing unit 100 under the control of the central processing unit 100; a battery 140 for supplying power to component parts; and a charging terminal 150 for electrically connecting the battery 140 to an external charging apparatus.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a control block diagram showing a multifunctional PDA in accordance with the present invention;

FIG. 2 is a control block diagram of the PDA with respect to a bar code recognition function;

FIG. 3 is a control block diagram of the PDA with respect to a pass card function;

FIG. 4 is a control block diagram of the PDA with respect to a memory stick input function;

FIG. 5 is a control block diagram of the PDA with respect to a remote control function;

FIG. 6 is a control block diagram of the PDA with respect to a camera function;

FIG. 7 is a perspective view showing the appearance of the PDA; and

FIG. 8 is a perspective view showing the use of the display of the PDA with respect to the remote control function.

### BEST MODE FOR CARRYING OUT THE INVENTION

Hereinafter, a PDA in accordance with an embodiment of the present invention is described with reference to the accompanying drawings.

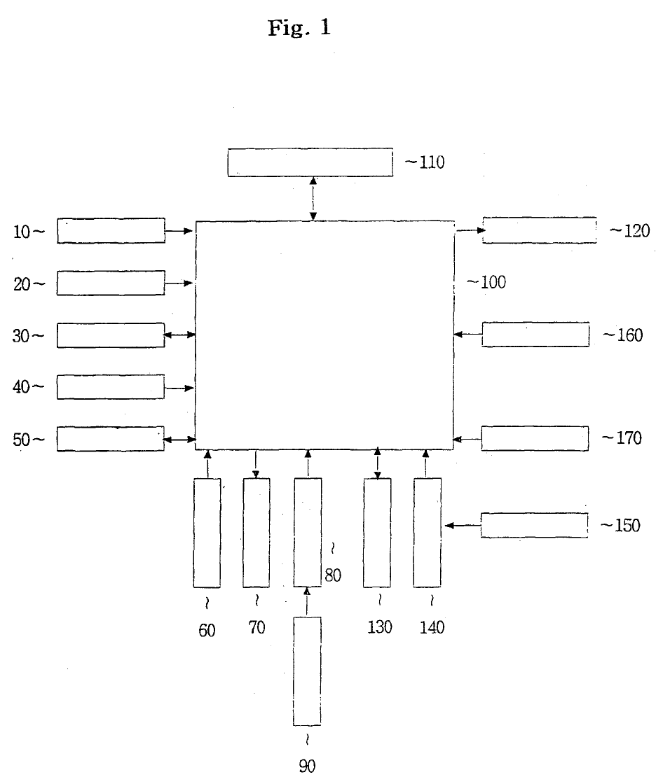

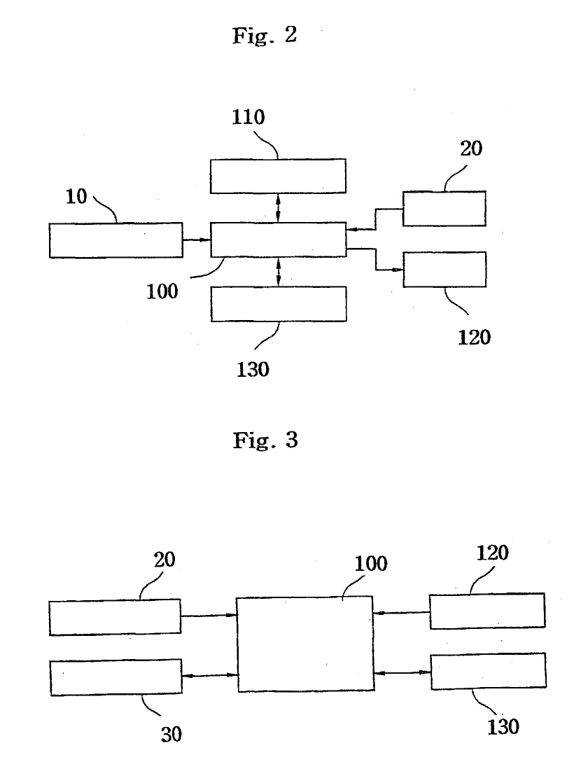

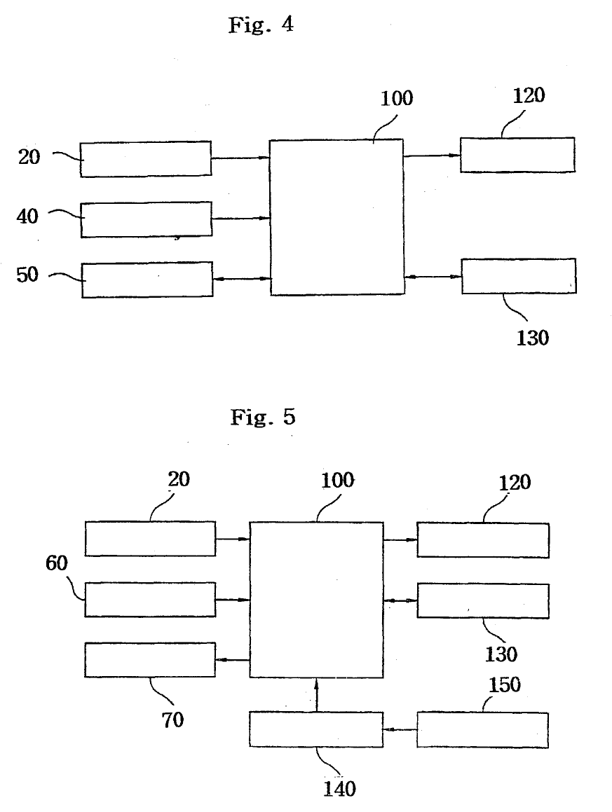

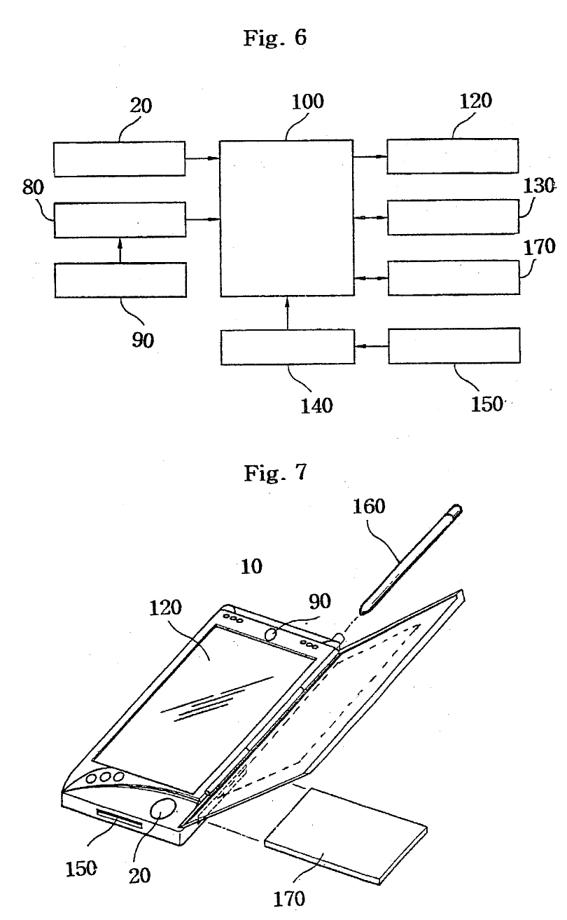

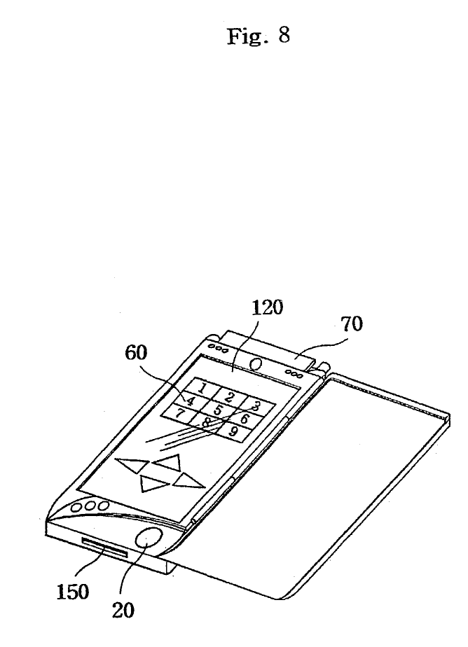

FIG. 1 is a control block diagram showing a multifunctional PDA in accordance with the present invention. FIG. 2 is a control block diagram of the PDA with respect to a bar code recognition function. FIG. 3 is a control block diagram of the PDA with respect to a pass card function. FIG. 4 is a control block diagram of the PDA with respect to a memory stick input function. FIG. 5 is a control block diagram of the PDA with respect to a remote control function FIG. 6 is a control block diagram of the PDA with respect to a camera function. FIG. 7 is a perspective view showing the appearance of the PDA. FIG. 8 is a perspective view showing the use of the display of the PDA with respect to the remote control function.

As shown in FIG. 2, when the PDA of the present invention performs a bar code recognition function, the PDA is comprised of a bar code recognition unit 10 for recognizing a bar code attached to a product, a data storage unit 130 for storing product information corresponding to bar codes, a key input unit 20 for inputting the commands of a user, a central processing unit 100 for interpreting the bar code recognized by the bar code recognition unit 10, searching the data storage unit 130 for product information such as the price of the product, selling places and the like, and outputting payment and delivery signals in response to the payment command inputted through the key input unit 20, a data transmission/reception unit 110 for transmitting a product delivery request signal to a corresponding selling place in response to product information outputted from the central processing unit 100 and transmitting a payment request signal to one of banking facilities, and a display 120 for displaying the operation of the central processing unit 100.

Accordingly, when a user carrying the PDA allows the PDA to recognize a bar code attached to a product to purchase after choosing the product at a shopping place such as a shopping mall or department store, the bar code recognition unit 10 recognizes the bar code attached to the product and the payment command of the user is inputted through the key input unit 20.

The central processing unit 100 interprets the bar code recognized by the bar code recognition unit 10, searches the data storage unit 130 for product information such as the price of the product, selling places and the like, and outputs payment and delivery signals in response to the payment command inputted through the key input unit 20. In this case, a many pieces of product information corresponding to bar codes are stored in the data storage unit 130, and new pieces of product information are downloaded from an additional server through data communication and stored in the data storage unit 130.

The data transmission/reception unit 110 transmits a product delivery request signal to a corresponding selling place in response to product information outputted from the central processing unit 100 and transmits a payment request signal to one of banking facilities. The display 120 displays the operation of the central processing unit 100.

Accordingly, a user carrying the PDA allows the PDA to recognize a bar code attached to a product to purchase after choosing the product at a shopping place such as a shopping mall, department store or the like, so the product can be purchased without additional purchasing/payment procedures and delivered to a desired location.

As depicted in FIG. 3, when the PDA of the present invention performs a pass card function, there are utilized a key input unit 20 for inputting the commands of a user through keys, a pass card process unit 30 for allowing an unique number to be recognized when taking or getting off a subway train or bus, a central processing unit 100 for controlling the input operation of the key input unit 20 and the process operation of the pass card process unit 30 and storing the information of the input and process operations in the data storage unit 130, and a display 120 for displaying the operation and process results of the central processing unit 100 under the control of the central processing unit 100.

The operation of this PDA of the present invention is described in detail.

A user normally utilizes the general PDA function of the PDA by manipulating the key input unit 20.

If a user brings the PDA near the card recognition means of the subway train or bus when taking or getting off a subway train or bus, the pass card process unit 30 of the PDA allows an unique number inputted to the PDA to be recognized by the card recognition means and a transportation fare to be paid. In this case, the pass card process unit 30 is preferably a magnetic recording type.

The central processing unit 100 controls the input operation of the key input unit 20 and the process operation of the pass card process unit 30 and stores the information of the input and process operations in the data storage unit 130. The display 120 displays the operation and process results of the central processing unit 100 under the control of the central processing unit 100.

In brief, if a user utilizes a pass card function when taking or getting off a subway train or bus, an unique number recorded in the PDA is immediately recognized and a transportation fare is paid, thereby improving the convenience of the user.

As illustrated in FIG. 4, when the PDA of the present invention performs a memory stick input function, the PDA is comprised of a key input unit 20 for inputting the commands of a user through keys, a pen type memory stick 160 for inputting the commands of the user, a memory stick input unit 40 for receiving the input of the memory stick 160, a character recognition unit 50 for converting into characters contents inputted through the memory stick input unit 40 through a translation process of analogous keyboard operations and transmitting the characters to each of applications, a central processing unit 100 for controlling the input operation of the memory stick input unit 40 and the process operation of the character recognition unit 50 and storing the information of the input and process operations in the data storage unit 130, and a display 120 for displaying the operation and process results of the central processing unit 100 under the control of the central processing unit 100.

The operation of this PDA of the present invention is described below.

A user inputs commands through the key input unit 20 or memory stick input unit 40 in a handwriting manner using the memory stick 160.

The character recognition unit 50 converts into characters contents inputted through the memory stick input unit 40 through a translation process of analogous keyboard operations and transmitting the characters to each of applications.

In this case, the central processing unit 100 controls the input operation of the key input unit 20 and the memory stick input unit 40 and the process operation of the character recognition unit 50, and stores the inputted and processed contents in the data storage unit 130. Additionally, the display 120 displays the operation and process results of the central processing unit 100 under the control of the central processing unit 100.

Accordingly, when a user uses a memory stick, the user can input characters through a memory stick in a handwriting manner and the PDA recognizes the characters and processes the characters the same as those inputted through a keyboard, thereby facilitating the use of the PDA.

As shown in FIG. 5, when the PDA of the present invention carries out a remote control function, the PDA of the present invention is comprised of a key input unit 20 for inputting the commands of a user through keys, a touch screen input unit 60 for inputting the remote controller manipulating commands of a user, an infrared transmission unit 70 for transmitting remote controller manipulating signals to various electronic devices such as televisions, video players, audio players, etc., a central processing unit 100 for controlling the input operation of the key input unit 20 and the touch screen input unit 60 and the process operation of the infrared transmission unit 70, a data storage unit 130 for storing data required for the control operation of the central processing unit 100, a display 120 for displaying manipulation keys and the operation and results of the manipulation keys under the control of the central processing unit 100, a battery 140 for supplying power to component parts, and a charging terminal 150 for electrically connecting the battery 140 to an external charging apparatus.

The operation of this PDA is described below.

The manipulation keys are displayed on the display 120 so as to manipulate a variety of electronic devices such as a television, a video player, an audio player, etc. under the control of the central processing unit 100.

Accordingly, a user inputs a manipulation command through the touch screen input unit 60 recognized on the display 120, and the central processing unit 100 processes manipulation signal and transmits the processed manipulation signal to one of various electronic devices through the infrared transmission unit 70.

Additionally, the central processing unit 100 controls the input operation of the key input unit 20 and the touch screen input unit 60 and the process operation of the infrared transmission unit 70, and stores inputted and processed data in the data storage unit 130. The display 120 displays operation and results under the control of the central processing unit 100.

The battery 140 supplies power to component parts, and is charged with electricity through the charging terminal 150 while being electrically connected with an external charging apparatus.

As shown in FIG. 6, when the PDA of the present invention carries out a camera function, there are utilized a key input unit 20 for inputting the commands of a user, a charge coupled device 90 for inputting images, a camera control unit 80 for processing the images inputted through the charge coupled device 90, a central processing unit 100 for controlling the input operation of the key input unit 20 and the process operation of the camera control unit 80 and storing inputted and processed image data in the data storage unit 130, a detachable memory 170 for storing the image data under the control of the central processing unit 100, a display 120 for displaying operation and results under the control of the central processing unit 100, a battery 140 for supplying power to component parts, and a charging terminal 150 for electrically connecting the battery 140 to an external charging apparatus.

The operation of the PDA of the present invention regarding the camera function is described below.

A user photographs a desired image through the charge coupled device 90 and the key input unit 20. This image is inputted to and processed in the camera control unit 80.

Thereafter, the central processing unit 100 controls the input operation of the key input unit 20 and the process operation of the camera control unit 80, and stores inputted and processed image data in the data storage unit 130.

Additionally, the central processing unit 100 can store the image data in the detachable memory 170. The memory 170 generally has a memory capacity of 4 to 8 Mbytes.

Additionally, the charge coupled device 90 has a user identification function based on iris or fingerprint identification.

Meanwhile, the display 120 displays operation and results under the control of the central processing unit 100.

The battery 140 supplies power to component parts, and is charged with electricity through the charging terminal 150 while being electrically connected with an external charging apparatus.

### INDUSTRIAL APPLICABILITY

As described above, the present invention provides a multifunctional PDA, in which a general PDA is provided with a bar code recognition function, so a user can purchase products without additional purchasing/payment procedures and have the products delivered to desired locations. Additionally, the present invention is to provide a PDA, in which a general PDA is provided with a pass card function, so if a user utilizes a pass card function when taking or getting off a subway train or bus, a unique number recorded in the PDA is immediately recognized and a transportation fare is paid, thereby improving the convenience of the user. Additionally, the present invention is to provide a PDA, in which a general PDA is provided with a memory stick function, so a user can input characters through a memory stick in a handwriting manner and the PDA recognizes the characters and processes the characters the same as those inputted through a keyboard, thereby facilitating the use of the PDA. Additionally, the present invention is to provide a PDA, in which a general PDA is provided with a remote control function, so a user can remotely and conveniently control a variety of electronic devices such a television, a video player, an audio player, etc. Additionally, the present invention is to provide a PDA, in which a general PDA is provided with a camera function, so a user can photograph a desired image and identify himself through iris or fingerprint identification using a charge coupled device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A multifunctional PDA, comprising:
a bar code recognition unit 10 for recognizing a bar code attached to a product;
a key input unit 20 for inputting the commands of a user through keys;
a pass card process unit 30 for allowing an unique number to be recognized when taking or getting off a subway train or bus;
a pen type memory stick 160 for inputting the commands of the user;
a memory stick input unit 40 for receiving the input of the memory stick 160;
a character recognition unit 50 for converting into characters contents inputted through the memory stick input unit 40 through a translation process of analogous keyboard operations and transmitting the characters to each of applications;
a touch screen input unit 60 for inputting the remote controller manipulating commands of a user;
an infrared transmission unit 70 for transmitting remote controller manipulating signals to various electronic devices such as televisions, video players, audio players, etc.;
a charge coupled device 90 for inputting images;
a camera control unit 80 for processing the images inputted through the charge coupled device 90;
a data storage unit 130 for storing product information corresponding to bar codes, contents inputted and processed through the pass card processing unit 30, data required to be controlled by a central processing unit, and image data inputted and processed through the key input unit 20 and the camera control unit 80;
a central processing unit 100 for interpreting the bar code recognized by the bar code recognition unit 10, searching the data storage unit 130 for product information such as the price of the product, selling places and the like, outputting payment and delivery signals in response to the payment command inputted through the key input unit 20, controlling and storing the input and process operation of the key input unit 20 and pass card processing unit 30; controlling the input operation of the memory stick input unit 40 and the process operation of the character recognition unit 50, controlling and storing the input operation of the key input unit 20 and the touch screen input unit 60 and the process operation of the infrared transmission unit 70, and controlling and storing the input operation of the key input unit 20 and the process operation of the camera control unit 80;
a data transmission/reception unit 110 for transmitting a product delivery request signal to a corresponding selling place in response to product information outputted from the central processing unit 100 and transmitting a payment request signal to one of banking facilities;
a display 120 for displaying the operation and process results of the central processing unit 100 under the control of the central processing unit 100;
a battery 140 for supplying power to component parts; and
a charging terminal 150 for electrically connecting the battery 140 to an external charging apparatus.

2. A multifunctional PDA, comprising:
a bar code recognition unit 10 for recognizing a bar code attached to a product;
a data storage unit 130 for storing product information corresponding to bar codes;
a key input unit 20 for inputting the commands of a user;
a central processing unit 100 for interpreting the bar code recognized by the bar code recognition unit 10, searching the data storage unit 130 for product information such as the price of the product, selling places and the like, and outputting payment and delivery signals in response to the payment command inputted through the key input unit 20;
a data transmission/reception unit 110 for transmitting a product delivery request signal to a corresponding selling place in response to product information outputted from the central processing unit 100 and transmitting a payment request signal to one of banking facilities; and
a display 120 for displaying operation of the central processing unit 100.

3. The multifunctional PDA according to claim 2, wherein said data storage unit frequently downloads and stores new pieces of product information from an additional server through data communication.

4. A multifunctional PDA, comprising:
a key input unit 20 for inputting the commands of a user through keys;
a pass card process unit 30 for allowing an unique number to be recognized when taking or getting off a subway train or bus;
a central processing unit 100 for controlling the input operation of the key input unit 20 and the process operation of the pass card process unit 30 and storing the information of the input and process operations in the data storage unit 130; and
a display 120 for displaying the operation and process results of the central processing unit 100 under the control of the central processing unit 100.

5. The multifunctional PDA according to claim 5, wherein said pass card process unit 30 is preferably a magnetic recording type.

6. A multifunctional PDA, comprising:
a pen type memory stick 160 for inputting the commands of the user;
a memory stick input unit 40 for receiving the input of the memory stick 160;
a character recognition unit 50 for converting into characters contents inputted through the memory stick input unit 40 through a translation process of analogous keyboard operations and transmitting the characters to each of applications;
a central processing unit 100 for controlling the input operation of the memory stick input unit 40 and the process operation of the character recognition unit 50 and storing the information of the input and process operations in the data storage unit 130; and
a display 120 for displaying the operation and process results of the central processing unit 100 under the control of the central processing unit 100.

7. The multifunctional PDA according to claim 6, further comprising a key input unit for inputting the commands of a user through keys.

8. A multifunctional PDA, comprising:
a key input unit 20 for inputting the commands of a user through keys,
a touch screen input unit 60 for inputting the remote controller manipulating commands of a user,
an infrared transmission unit 70 for transmitting remote controller manipulating signals to various electronic devices such as televisions, video players, audio players, etc.,
a central processing unit 100 for controlling the input operation of the key input unit 20 and the touch screen input unit 60 and the process operation of the infrared transmission unit 70, and
a data storage unit 130 for storing data required for the control operation of the central processing unit 100, and
a display 120 for displaying manipulation keys and the operation and results of the manipulation keys under the control of the central processing unit 100.

9. A multifunctional PDA, comprising:
a key input unit 20 for inputting the commands of a user;
a charge coupled device 90 for inputting images;
a camera control unit 80 for processing the images inputted through the charge coupled device 90;
a central processing unit 100 for controlling the input operation of the key input unit 20 and the process operation of the camera control unit 80 and storing inputted and processed image data in the data storage unit 130;
a detachable memory 170 for storing the image data under the control of the central processing unit 100; and
a display 120 for displaying operation and results under the control of the central processing unit 100.

10. The multifunctional PDA according to claim 9, wherein said charge coupled device has a user identification function based on iris or fingerprint identification.
